(19) United States
(12) Patent Application Publication
(10) Pub. No.: US 2016/0225294 A1
(43) Pub. Date: Aug. 4, 2016

(54) Decals for smart phones and other electronic devices

(71) Applicant: Donald E. Hodgson, Erie, CO (US)

(72) Inventor: Donald E. Hodgson, Erie, CO (US)

(21) Appl. No.: 14/544,643

(22) Filed: Jan. 29, 2015

(51) Int. Cl. G09F 3/10

(52) U.S. Cl. CPC G09F 3/10

(57) ABSTRACT

A decal or sticker that can be applied to the screen of a cell/smart phone and or tablet, and does not effect the function of the electronic device.

### FIELD OF THE INVENTION

This invention is directed to cell/smart phones, tablets, where the decal is applied to a phone or tablet. The decal maybe for advertising, sports, holiday's, or just to personalize your phone.

### BACKGROUND OF THE INVENTION

There have been no suggestions in prior art to a cell/smart phones and tablets decal as this.

### BRIEF DESCRIPTION OF THE INVENTION

This invention relates to cell/smart phones and or tablets where a form of art is made from a static cling material into a decal and is attached to the screen of a phone or tablet. The decal can be removed and replaced at any time.

### BRIEF DESCRIPTION OF THE DRAWINGS

FIG. 1 is a front view of a cell/smart phone with a decal on the screen

FIG. 2 is a front view of a tablet with a decal on the screen

### DETAILED DESCRIPTION OF THE INVENTION

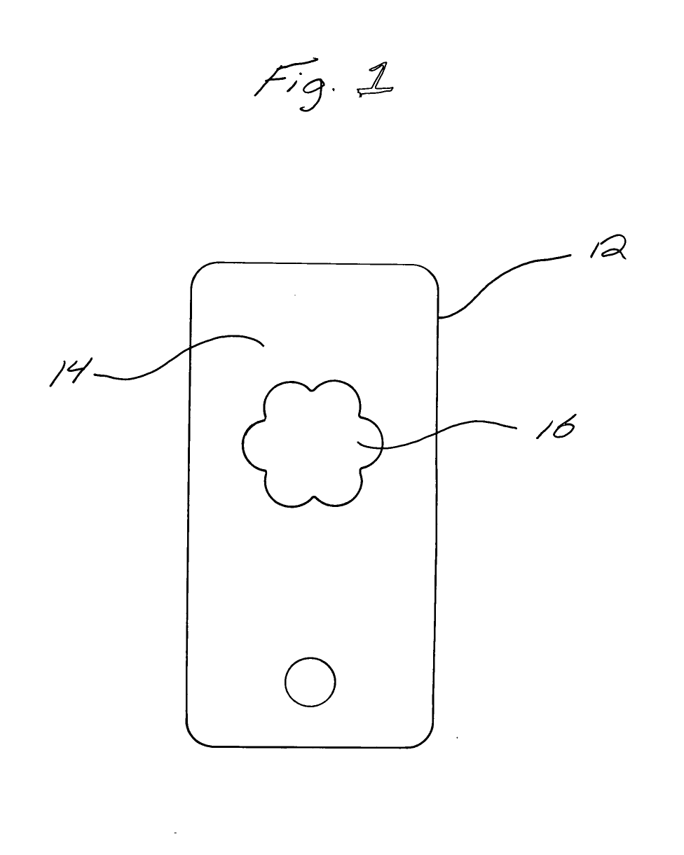

In FIG. 1 there is illustrated a cell/smart phone 12 with a screen 14 located on screen 14 is a decal 16.

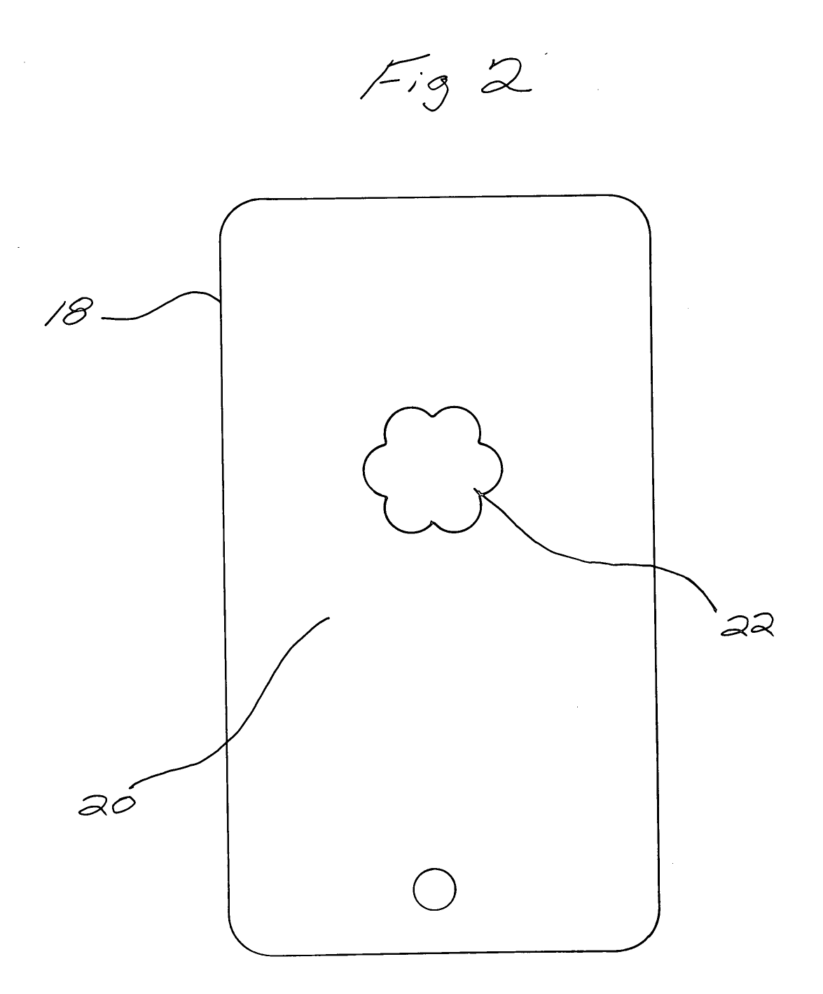

In FIG. 2 there is illustrated a tablet 18 with a screen 20 located on screen 20 is a decal 22.

What is claimed:

1. A decal made from a transparent or semi-transparent static cling material that can be made into any shape, and attached to and/or removed from the screen of a cell/smart phone, at any time.

2. A decal made from a transparent or semi-transparent static cling material that can be made into any shape, and attached to and/or removed from the screen of a tablet at any time.
